(19) United States
(12) Patent Application Publication
(10) Pub. No.: US 2009/0174373 A1
(43) Pub. Date: Jul. 9, 2009

(54) CLAMP CIRCUIT AND COMBINATIONAL CIRCUIT THEREOF

(75) Inventors: LI SHENG CHENG, HSINCHU (TW); YU MIN SUN, HSINCHU (TW); CHU YU CHU, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., HSINCHU (TW)

(21) Appl. No.: 12/203,059

(22) Filed: Sep. 2, 2008

(30) Foreign Application Priority Data
Jan. 9, 2008 (TW) 097100778

(51) Int. Cl. G05F 1/613

(52) U.S. Cl. 323/223

(57) ABSTRACT

A clamp circuit comprises a first transistor, a second transistor and a voltage-dividing circuit. The first transistor has a source terminal connected to a reference voltage, and has a drain terminal grounded through a current source. The second transistor has a gate terminal connected to the gate and drain terminals of the first transistor, and has a drain terminal grounded. The voltage-dividing circuit is connected to an input voltage end, an output voltage end and a source terminal of the second transistor for providing a clamping voltage.

### BACKGROUND OF THE INVENTION

1. Field of the Invention

The present invention relates to a clamp circuit, and more particularly, to a high precision clamp circuit.

2. Description of the Related Art

A clamp circuit is used to transform an input voltage with a large range into a fixed output voltage. FIG. 1 shows a prior art clamp circuit, which includes a first resistor R1, a second resistor R2, a third resistor R3 and a zener diode D1. The first resistor R1 is connected to an input voltage and one end of the second resistor R2, respectively. The other end of the second resistor R2 is connected to one end of the third resistor R3, and acts as an output end. The other end of the third resistor R3 is grounded. The cathode of the zener diode D1 is connected to a common node of the first resistor R1 and the second resistor R2, and its anode is grounded.

When the input voltage exceeds a threshold such that the voltage of the common node of the first resistor R1 and the second resistor R2 exceeds the breakdown voltage of the zener diode D1, the zener diode D1 activates and the clamp circuit 10 enters an active state. Under the active state, the zener diode D1 operates in a reverse breakdown status, and thus its cathode voltage is fixed at a constant V_{clamp}. Meanwhile, its output voltage is equal

$$to \frac{R 2}{R 2 + R 3} {V}_{clamp} .$$

When its input voltage increases, the excessive voltage increases on the first resistor R1 and the excessive current flows to ground through the zener diode D1. Therefore, the output voltage is fixed at a constant.

However, the output voltage of the clamp circuit 10 is not easily controlled due to the accuracy requirement of the input voltage and process variation of the zener diode D1. Moreover, under different temperatures, the output voltage of the clamp circuit 10 varies dramatically. Therefore, it is not suitable to apply to a high precision circuit.

### SUMMARY OF THE INVENTION

The present invention proposes a clamp circuit which comprises a first transistor, a second transistor and a voltage-dividing circuit. The first transistor has a source terminal connected to a reference voltage, and has a drain terminal grounded through a current source. The second transistor has a gate terminal connected to the gate and drain terminals of the first transistor, and has a drain terminal grounded. The voltage-dividing circuit is connected to an input voltage end, an output voltage end and a source terminal of the second transistor for providing a clamping voltage.

The present invention proposes a combinational circuit applied to a clamp circuit. The combinational circuit is connected to a voltage-dividing circuit and comprises a first transistor and a second transistor. The first transistor has a source terminal connected to a reference voltage, and has a drain terminal grounded through a current source. The second transistor has a gate terminal connected to the gate and drain terminals of the first transistor, and has a source terminal connected to the voltage-dividing circuit.

### BRIEF DESCRIPTION OF THE DRAWINGS

The invention will be described according to the appended drawings in which:

FIG. 1 shows a prior art clamp circuit;

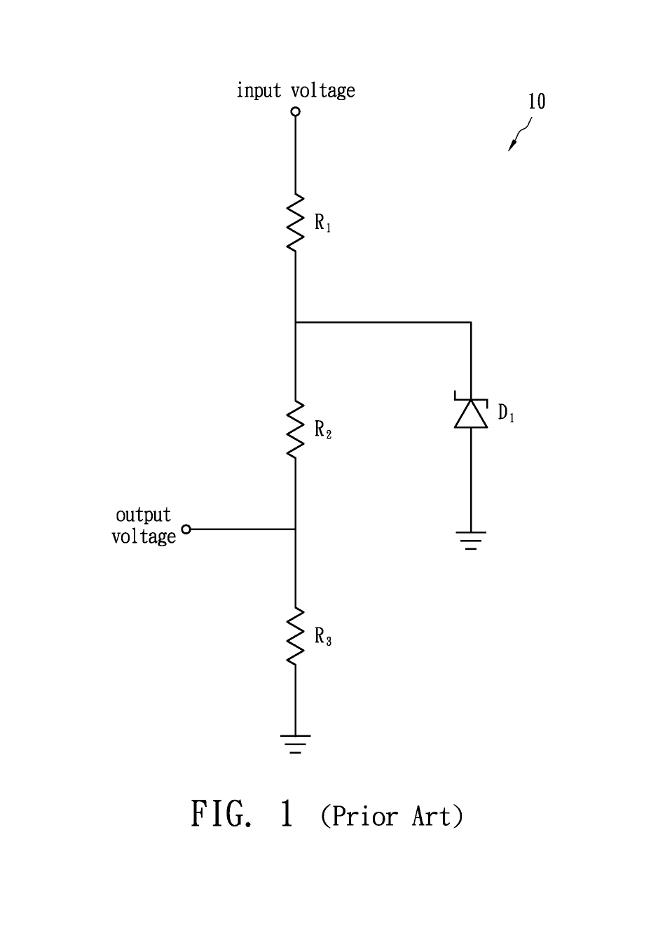

FIG. 2 shows a clamp circuit according to one embodiment of the present invention; and

FIG. 3 shows a clamp circuit according to another embodiment of the present invention.

### PREFERRED EMBODIMENT OF THE PRESENT INVENTION

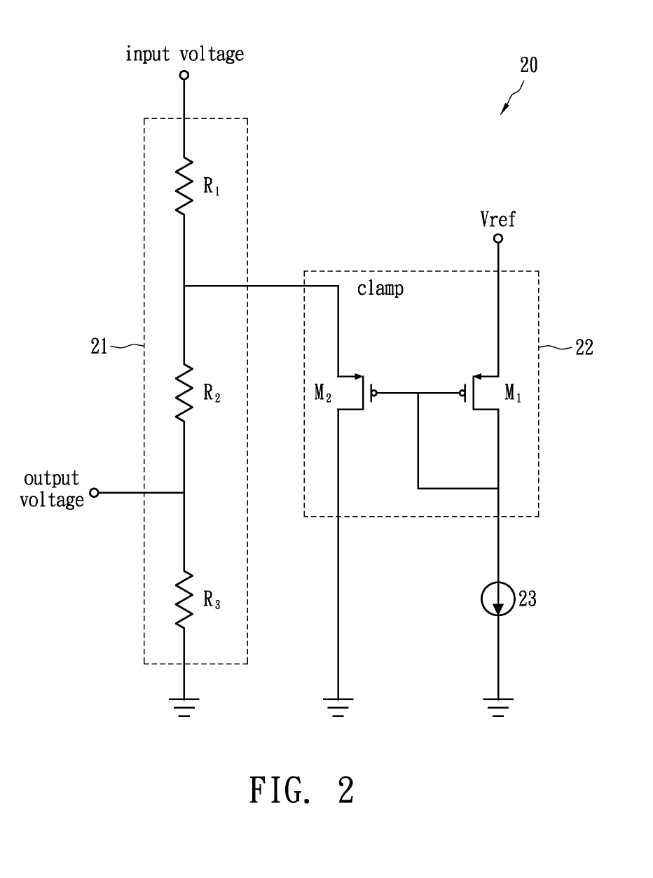

FIG. 2 shows a clamp circuit according to one embodiment of the present invention. The clamp circuit 20 includes a voltage-dividing circuit 21 and a combinational circuit 22. The voltage-dividing circuit 21 includes a first resistor R1, a second resistor R2 and a third resistor R3. The combinational circuit 22 includes a first transistor MI and a second transistor M2. One end of the first resistor R1 is connected to an input voltage. One end of the second resistor R2 is connected to the source terminal of the second transistor M2 and the other end of the first resistor R1. One end of the third resistor R3 is connected to an output voltage and the other end of the second resistor R2, and the other end of the third resistor R3 is grounded. The source terminal of the first transistor M1 is connected to a reference voltage V_{ref}, and its drain terminal is grounded through a current source 23. The gate terminal of the second transistor M2 is connected to the gate and drain terminals of the first transistor M1, and the drain terminal of the first transistor M1 is grounded. The size of the first transistor M1 is substantially equal to that of the second transistor M2, and the threshold voltage Vₜₕ₁ of the first transistor M1 is close to the threshold voltage Vₜₕ₂ of the second transistor M2.

When the input voltage is lower than a threshold, the second transistor M2 is not activated. Meanwhile, its output voltage is

$$\frac{R 3}{R 1 + R 2 + R 3} {V}_{in} .$$

When the input voltage gradually increases so as to exceed a threshold, the voltage of the source terminal of the second transistor M2 is greater than the reference voltage V_{ref} so as to activate the second transistor M2. Meanwhile, the clamp circuit 20 enters an active state. In the active state, because the threshold voltage Vₜₕ₁ of the first transistor M1 is substantially equal to the threshold voltage Vₜₕ₂ of the second transistor M2, the voltage V_{clamp} of the source terminal of the second transistor M2 is close to the reference voltage V_{ref}, and the output voltage is fixed at

$$\frac{R 3}{R 2 + R 3} {V}_{ref} .$$

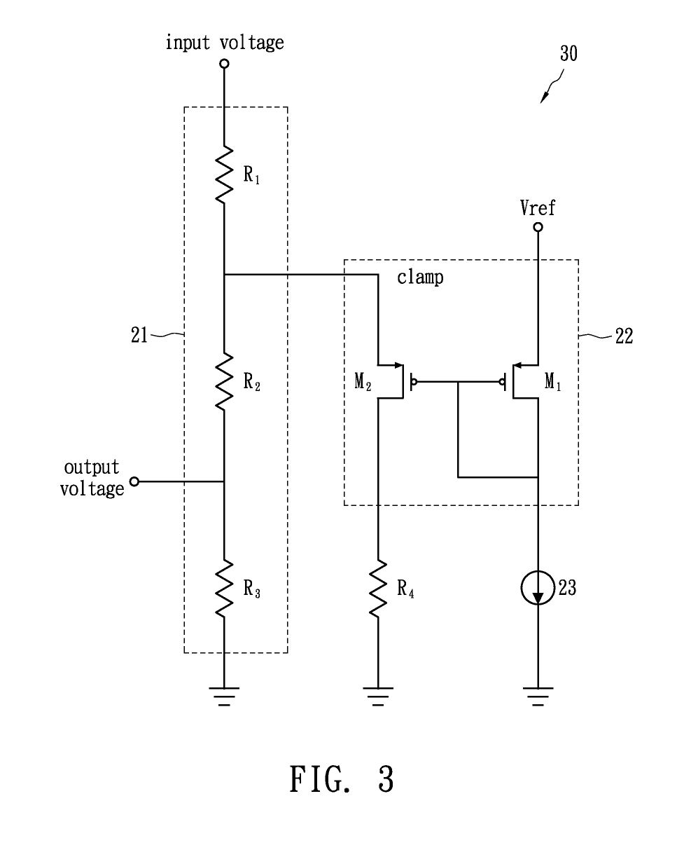

Preferably, the drain terminal of the second transistor M2 is grounded through a fourth resistor R4, as shown in FIG. 3. The fourth resistor R4 is used to simulate the drop voltage at the current source 23 so as to let V_{clamp} closely approximate V_{ref}.

The reference voltage V_{ref} is obtained from an internal stable voltage of a chip which exhibits a precise property to cause the output clamping voltage of the clamp circuit 20 to be more easily controlled. Moreover, because the relationship between the reference voltage V_{ref} and the variance of the temperature is converse to the relationship between the combinational circuit 22 and the variance of the temperature, a voltage drift resulting from the temperature variation is offset.

In conclusion, the present clamp circuit effectively controls the output voltage,

$$e . g . , \frac{Δ {V}_{out}}{Δ {V}_{in}}$$

after measurement is close to 0.3433%, and exhibits resistance against temperature variation, e.g.,

$$\frac{Δ {V}_{out} / {V}_{out}}{Δ T}$$

after measurement is close to

$$- 2865 \frac{ppm}{° C .} .$$

Therefore, the present invention is suitable to apply to a high precision circuit.

The above-described embodiments of the present invention are intended to be illustrative only. Numerous alternative embodiments may be devised by persons skilled in the art without departing from the scope of the following claims.

What is claimed is:

1. A clamp circuit, comprising:
a first transistor having a source terminal connected to a reference voltage, and having a drain terminal grounded through a current source;
a second transistor having a gate terminal connected to the gate and drain terminals of the first transistor, and having a drain terminal grounded; and
a voltage-dividing circuit connected to an input voltage end, an output voltage end and a source terminal of the second transistor for providing a clamping voltage.

2. The clamp circuit of claim 1, wherein the voltage-dividing circuit comprises:
a first resistor having one end connected to the input voltage end;
a second resistor having one end connected to the source terminal of the second transistor and the other end of the first resistor; and
a third resistor having one end connected to the output voltage end and the other end of the second resistor, and the other end of the third resistor grounded.

3. The clamp circuit of claim 1, wherein the drain terminal of the second transistor is grounded through a fourth resistor.

4. The clamp circuit of claim 1, which is implemented in a single chip.

5. The clamp circuit of claim 1, wherein the reference voltage is an internal stable voltage inside a chip.

6. The clamp circuit of claim 1, wherein the size of the first transistor is substantially equal to that of the second transistor.

7. A combinational circuit applied to a clamp circuit, wherein the combinational circuit is connected to a voltage-dividing circuit and comprises:
a first transistor having a source terminal connected to a reference voltage, and having a drain terminal grounded through a current source; and
a second transistor having a gate terminal connected to the gate and drain terminals of the first transistor, and having a source terminal connected to the voltage-dividing circuit.

8. The combinational circuit of claim 7, wherein the drain terminal of the second transistor is grounded through a resistor.

9. The combinational circuit of claim 7, which is implemented in a single chip.

10. The combinational circuit of claim 7, wherein the reference voltage is an internal stable voltage inside a chip.

11. The combinational circuit of claim 7, wherein the size of the first transistor is substantially equal to that of the second transistor.
